(19) United States
(12) Patent Application Publication
(10) Pub. No.: US 2015/0249718 A1
(43) Pub. Date: Sep. 3, 2015

(54) PERFORMING ACTIONS ASSOCIATED WITH INDIVIDUAL PRESENCE

(71) Applicants: Chris Huybregts, Kirkland, WA (US); Jaeyoun Kim, Issaquah, WA (US); Michael A. Betser, Kirkland, WA (US); Thomas C. Butcher, Seattle, WA (US); Yaser Masood Khan, Bothell, WA (US)

(72) Inventors: Chris Huybregts, Kirkland, WA (US); Jaeyoun Kim, Issaquah, WA (US); Michael A. Betser, Kirkland, WA (US); Thomas C. Butcher, Seattle, WA (US); Yaser Masood Khan, Bothell, WA (US)

(21) Appl. No.: 14/194,031

(22) Filed: Feb. 28, 2014

(51) Int. Cl. H04L 29/08; H04N 7/18; G06K 9/00

(52) U.S. Cl. CPC H04L 67/24; H04L 67/16; G06K 9/00228; H04N 7/183

(57) ABSTRACT

Devices are often configurable to perform actions automatically in response to a condition, such as an alarm presented at a time or date of a meeting; a message associated with a location specified by a geofence; or an automated response to a received message. Such conditions may be tangentially applied to actions involving an individual (e.g., a reminder presented during an anticipated meeting or a geofence associated with the individual's office), but may result in false positives when the individual is not actually present, and false negatives when an unanticipated presence of the individual arises. Instead, a device may be configured to detect the presence of the individual with the user (e.g., capturing a photo of the environment of the user, and identifying the face of the individual in the photo), and to perform an action for the user during the detected presence of the individual with the user.

### BACKGROUND

Within the field of computing, many scenarios involve a device that performs actions at the request of a user in response to a set of conditions. As a first example, a device may perform an action at a specified time, such as an alarm that plays a tone, or a calendar that provides a reminder of an appointment. As a second example, a device may perform an action when the device enters a particular location, such as a “geofencing” device that provides a reminder message when the user carries the device into a set of coordinates that define a specified location. As a third example, a device may perform an action in response to receiving a message from an application, such as a traffic alert advisory received from a traffic monitoring service that prompts a navigation device to recalculate a route.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While many devices perform actions in response to various conditions, one condition that devices do not typically monitor and/or respond is the presence of other individuals with the user. For example, a user may be in physical proximity to one or more particular individuals, such as family members, friends, or professional colleagues, and may wish the device to perform an action involving the individual, such as presenting a reminder message about the individual (e.g., “today is Joe's birthday”) or to convey to the individual (e.g., “ask Joe to buy bread at the market”), or to display an image that the user wishes to display to the individual. However, such actions are typically achieved by the user realizing the proximity of the specified individual, remembering the action to be performed during the presence of the individual, and invoking the action on the device.

Alternatively, the user may configure a device to perform an action involving a user during an anticipated presence of the individual, such as a date- or time-based alert for an anticipated meeting with the individual; a geofence-based action involving a location where the individual is anticipated to be present, such as the individual's home or office; or a message-based action involving a message received from the individual. However, such techniques may result in false positives when the individual is not present (e.g., the performance of the action even if the user and/or the individual do not attend the anticipated meeting; a visit to the individual's home or office while the individual is absent; and an automatically generated message from the individual, such as an automated “out of office” message), as well as false negatives when the individual is unexpectedly present (e.g., a chance encounter with the individual). Such techniques are also applicable only when the user is able to identify a condition that is tangentially associated with the individual's presence, and therefore may not be applicable; e.g., the user may not know the individual's home or office location or may not have an anticipated meeting with the individual, or the individual may not have a device that is capable of sending messages to the user.

Presented herein are techniques for configuring devices to perform actions that involve particular individuals upon detecting the presence of the individual. For example, a user may request the device to present a reminder message during the next physical proximity of a specified individual. Utilizing a camera, the device may continuously or periodically evaluate an image of the environment of the device and the user, and may apply a face recognition technique to the images of the environment in order to detect the face of the specified individual. Such detection may connote the presence of the individual with the user, and may prompt the device to present the reminder message to the user. In this manner, the device may fulfill requests from the user to perform actions involving individuals and during the presence of the individual with the user, in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a device executing actions in response to rules specifying various conditions.

FIG. 2 is an illustration of an exemplary scenario featuring a device executing an action in response to a detected presence of an individual with the user, in accordance with the techniques presented herein.

FIG. 3 is an illustration of an exemplary method for configuring a device to execute an action in response to a detected presence of an individual with the user, in accordance with the techniques presented herein.

FIG. 4 is an illustration of an exemplary system for configuring a device to execute an action in response to a detected presence of an individual with the user, in accordance with the techniques presented herein.

FIG. 5 is an illustration of an exemplary computer-readable medium comprising processor-executable instructions configured to embody one or more of the provisions set forth herein.

FIG. 6 is an illustration of an exemplary device in which the techniques provided herein may be utilized.

FIG. 7 is an illustration of an exemplary scenario featuring a device configured to utilize a first technique to detect a presence of an individual for a user, in accordance with the techniques presented herein.

FIG. 8 is an illustration of an exemplary scenario featuring a device configured to utilize a second technique to detect a presence of an individual for a user, in accordance with the techniques presented herein.

FIG. 9 is an illustration of an exemplary scenario featuring a device configured to receive a conditioned request for an action involving an individual, and to detect a fulfillment of the condition, through the evaluation of a conversation between the user and various individuals, in accordance with the techniques presented herein.

FIG. 10 is an illustration of an exemplary scenario featuring a device configured to perform an action involving a user while avoiding an interruption of a conversation between the user and an individual, in accordance with the techniques presented herein.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A. Introduction

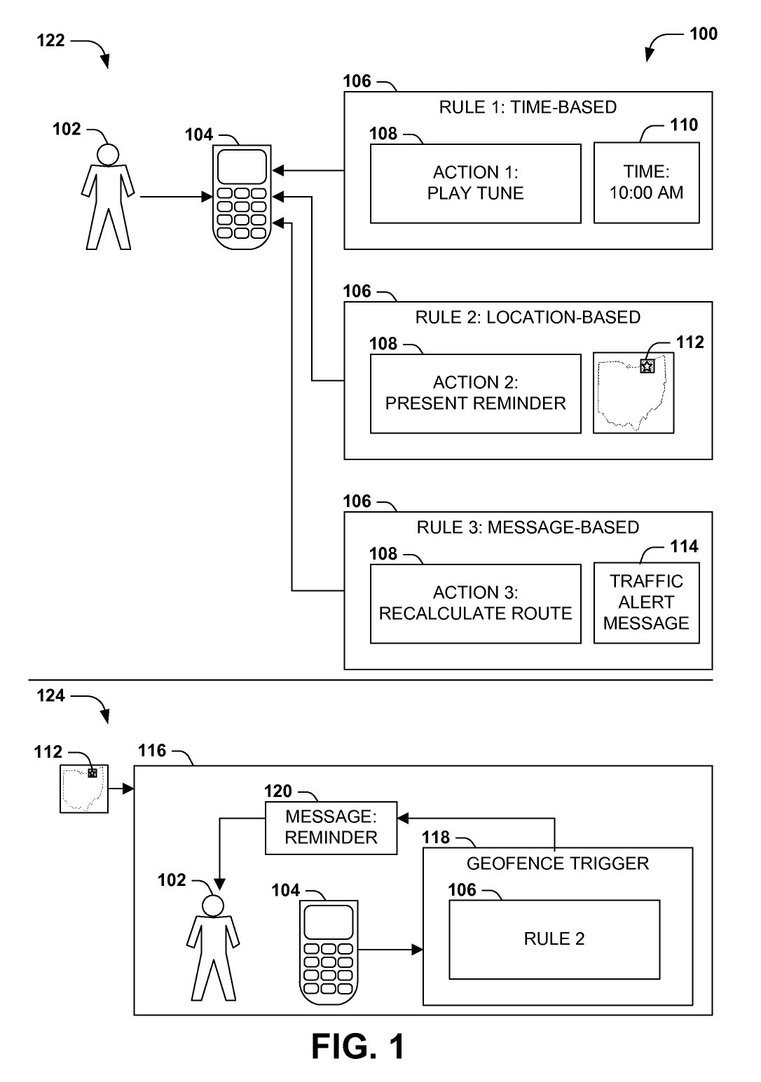

FIG. 1 presents an illustration of an exemplary scenario 100 involving a user 102 of a device 104 that is configured to perform actions 108 on behalf of the user 102. In this exemplary scenario 100, at a first time 122, the individual 102 programs the device 104 with a set of rules 106, each specifying a condition 110 that may be detected by the device 104 and may trigger the performance of a specified action 108 on behalf of the user 102.

A first rule 106 specifies a condition 110 comprising a time or date on which the device 104 is to perform the action 108. For example, an alarm clock may play a tune at a specified time, or a calendar may present a reminder of an appointment at a particular time. The device 104 may be configured to fulfill the first rule 106 by monitoring a chronometer within the device 104, comparing the current time specified by the chronometer with the time specified in the rule 106, and upon detecting that the current time matches the time specified in the rule 106, invoking the specified action 108.

A second rule 106 specifies a condition 110 comprising a location 112, such as a “geofencing”-aware device that performs an action 108, such as presenting a reminder message, when the device 104 next occupies the location 112. The device 104 may be configured to fulfill the second rule 106 by monitoring a current set of coordinates of the device 104 indicated by a geolocation component, such as a global positioning system (GPS) receiver or a signal triangulator, and comparing the coordinates provided by the geolocation component with the coordinates of the location 112, and performing the action 108 when a match is identified.

A third rule 106 specifies a condition 110 comprising a message 114 received from a service, such as a traffic message from a traffic alert service warning about the detection of a traffic accident along a route of the user 102 and/or the device 104, or a weather alert message received from a weather alert service. The receipt of such a message 114 may trigger an action 108 such as recalculating the route of the user 102 to avoid the traffic or weather condition described in the message 114.

The device 104 may fulfill the requests from the user 102 by using input components to monitoring the conditions of the respective rules 106 and invoking the action 108 when such conditions arise. For example, at a second time point 124, the individual 102 may carry the device 104 into the bounds 116 defining the location 112 specified by the second rule 106. The device 104 may compare the current coordinates indicated by a geolocation component, and upon detecting the entry of the bounds 116 of the location 112, may initiate a geofence trigger 118 for the second rule 106. The device 104 may respond to the geofence trigger 118 by providing a message 120 to the user 102 in fulfillment of the second rule 106. In this manner, the device 104 may fulfill the set of rules 106 through monitoring of the specified conditions, and automatic invocation of the action 108 associated therewith.

While the types of rules 106 demonstrate a variety of conditions to which the device 104 may respond, one such condition that has not yet been utilized by devices is the presence of particular individuals with the user 102. For example, the user 102 may wish to show a picture on the user's device 104 to the individual, and may hope to remember to do so upon next encountering the individual. When the user 102 observes that the individual is present, the user 102 may remember the picture and invoke the picture application on the device 104. However, this process relies on the observational powers and memory of the individual 102 and the manual invocation of the action 108 on the device 104.

Alternatively, the user 102 may create the types of rules 106 illustrated in the exemplary scenario 100 of FIG. 1 in order to show the picture during an anticipated presence of the individual. As a first example, the user 102 may set an alarm for the date and time of a next anticipated meeting with the individual. As a second example, the user 102 may create a location-based rule 106, such as a geofence trigger 118 involving a location 112 such as the individual's home or office. As a third example, the user 102 may create a message-based rule 106, such as a request to send the picture to the individual upon receiving a message from the individual, such as a text message or email message.

However, such rules that are tangentially triggered by the individual's presence may result in false positives (e.g., either the user 102 or the individual may not attend a meeting; the individual may not be present when the user 102 visits the individual's home or office; or the user 102 receives a message from the individual when the individual is not present, such as an automated “out-of-office” response from the individual to the user 102 indicating that the individual is unreachable at present). Additionally, such tangential rules may result in false negatives (e.g., the user 102 may encounter the individual unexpectedly, but because the tangential conditions of the rule 106 are not fulfilled, the device 104 may fail to take any action). Finally, such rules 106 involve information about the individual of which the user 102 may not have (e.g., the user 102 may not know the individual's home address), or may not pertain to the individual (e.g., the individual may not have a device that is capable of sending messages to the device 104 of the user 102). In these scenarios, the application of the techniques of FIG. 1 may be inadequate for enabling the device 104 to perform an action 108 involving the presence of the individual with the user 102.

B. Presented Techniques

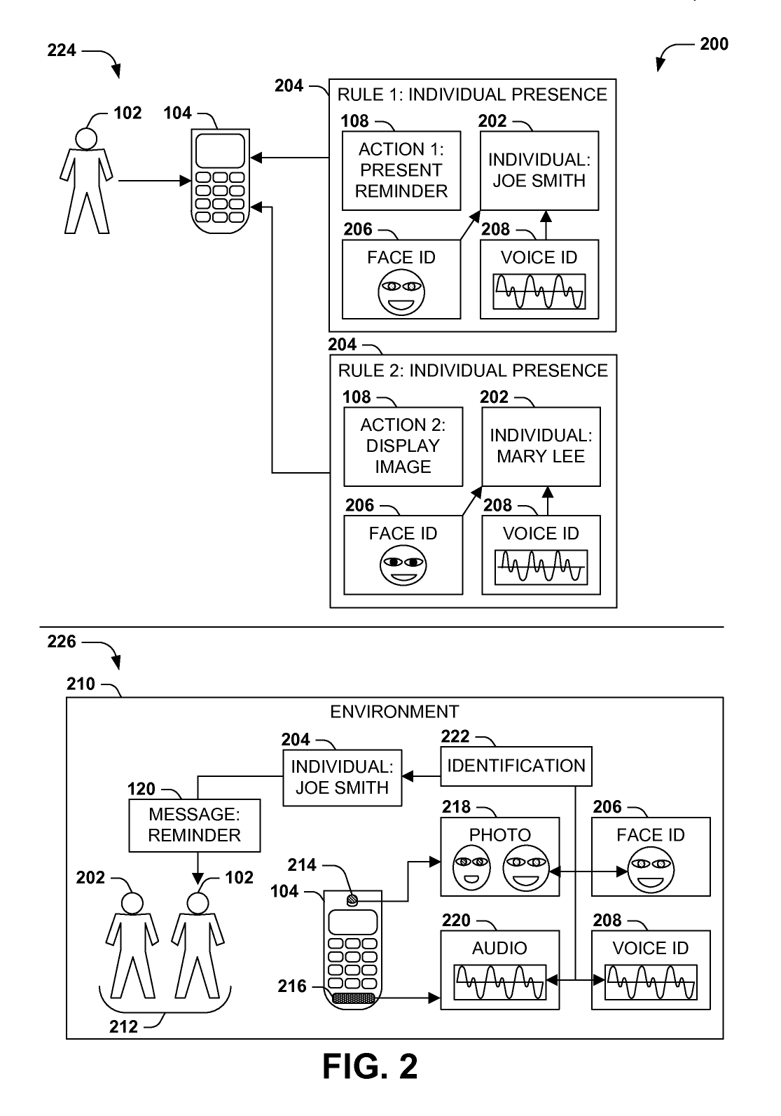

FIG. 2 presents an illustration of an exemplary scenario 200 featuring a device 104 that is configured to perform actions 108 upon detecting the presence of specified individual with the user 102 in accordance with these techniques presented herein. In this exemplary scenario 200, at a first time 224, an individual 102 may configure a device 104 to store a set of individual presence rules 204, each indicating the performance of an action 108 during the presence of a particular individual 202 with the individual 102. As a first example, a first individual presence rule 204 may specify that when an individual 202 known as Joe Smith is present, the device 104 is to invoke a first action 108, such as presenting a reminder. A second individual presence rule 204 may specify that when an individual 202 known as Mary Lee is present, the device 104 is to invoke a second action 108, such as displaying an image. The device 104 may also store a set of individual identifiers of for individual 202, such as a face identifier 206 of the face of the individual 202 and a voice identifier 208 of the voice of the individual 202.

At a second time 226, the individual 102 may be present in a particular environment 210, such as a room of a building or the passenger compartment of a vehicle. The device 104 may utilize one or more input components to detect a presence 212 of an individual 202 with the user 102 in the environment 210, according to the face identifiers 206 and/or voice identifiers 208 stored for the respective individuals 202. For example, the device 104 may utilize an integrated camera 214 to capture a photo 218 of the environment 210 of the individual 102; may detect the presence of one or more faces in the photo 218; and may compare the faces with the stored face identifiers 206. Alternatively or additionally, the device 104 may capture an audio sample 220 of the environment 210 of the individual 102; may detect and isolate the presence of one or more voices in the audio sample 220; and may compare the isolated voices with the stored voice identifiers 208. These types of comparisons may enable the device 214 to match a face in the photo 218 with the face identifier 206 of Joe Smith, and/or to match the audio sample 220 with the stored voice identifier 208 of Joe Smith thereby achieving an identification 222 of the presence of a known individual 202, such as Joe Smith, with the user 102. The device 104 may therefore perform the action 108 that is associated with the presence of Joe Smith with the individual 102, such as displaying a message 120 for the user 102 that pertains to Joe Smith (e.g., “ask Joe to buy bread”). In this manner, the device 104 may achieve the automatic performance of actions 108 responsive to detecting the presence 210 of individuals 202 with the user 102, in accordance with the techniques presented herein.

C. Exemplary Embodiments

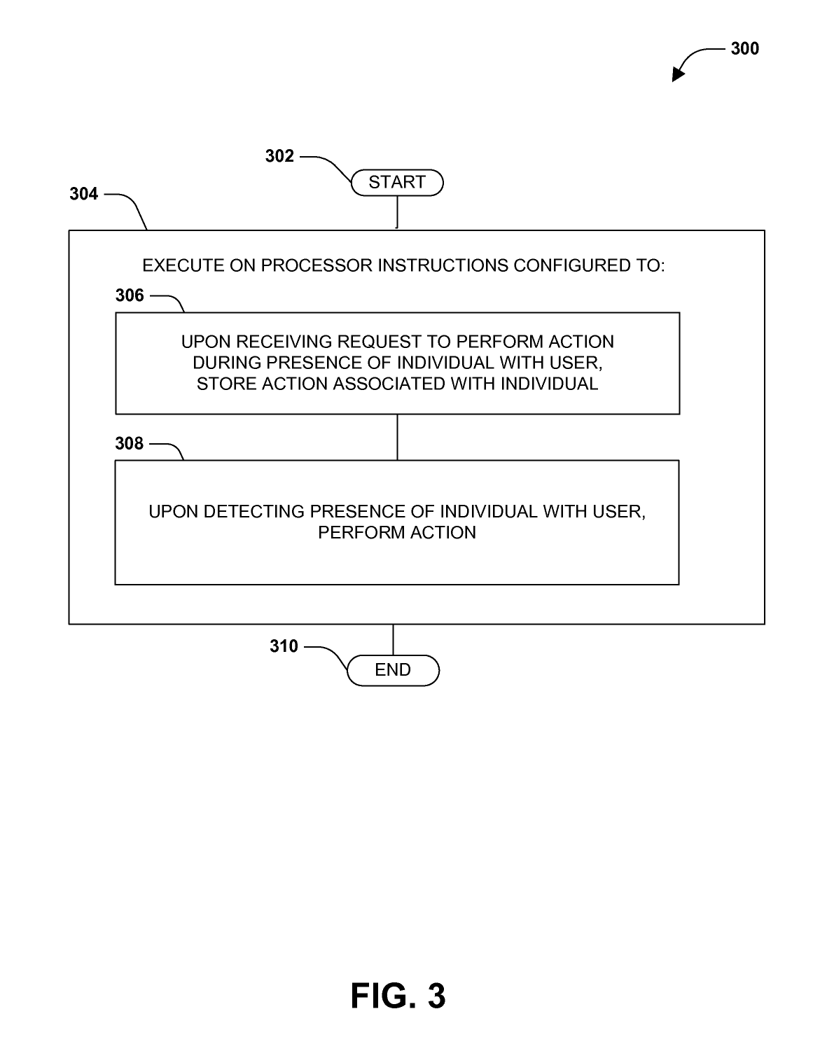

FIG. 3 presents a first exemplary embodiment of the techniques presented herein, illustrated as an exemplary method 302 of configuring devices 108 to fulfill requests of a user 102 to execute actions 108 during the presence of an individual 202 with the user 102. The exemplary method 300 may be implemented, e.g., as a set of instructions stored in a memory component of a device 104, such as a memory circuit, a platter of a hard disk drive, a solid-state storage device, or a magnetic or optical disc, and organized such that, when executed on a processor of the device 104, cause the device 104 to operate according to the techniques presented herein. The exemplary method 300 begins at 302 and involves executing 304 the instructions on a processor of the device 104. Specifically, the instructions cause the device to, upon receiving a request to perform an action 108 during a presence of an individual 202 with the user 102, store 306 the action 108 associated with the individual 202. The instructions also cause the device 104 to, upon detecting a presence of the individual 202 with the user 102, perform 308 the action 108. In this manner, the instructions cause the device to execute actions 108 during the presence of the individual 202 with the user 102, in accordance with the techniques presented herein, and so ends at 310.

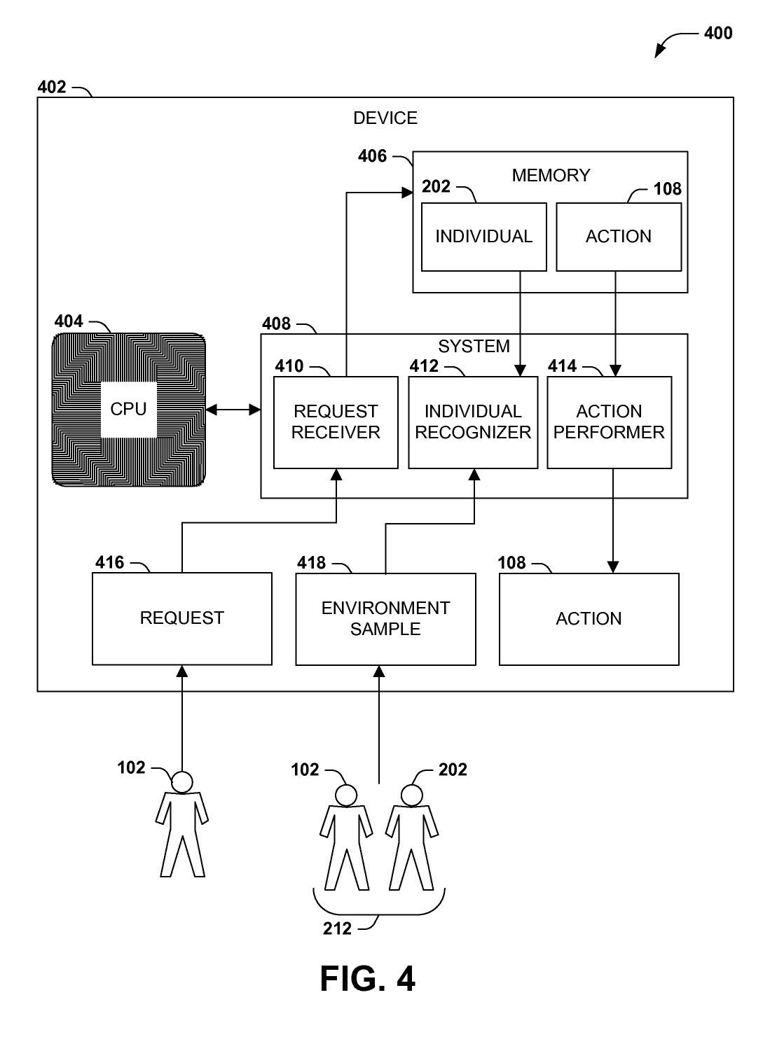

FIG. 4 presents a second exemplary embodiment of the techniques presented herein, illustrated as an exemplary scenario 400 featuring an exemplary system 408 configured to cause a device 402 to execute actions 108 while a user 102 is in the presence of the individual 202. The exemplary system 408 may be implemented, e.g., as a set of components respectively comprising a set of instructions stored in a memory component of the device 402, where the instructions of the respective components, when executed on a processor 404, cause the device 402 to perform a portion of the techniques presented herein. The exemplary system 408 includes a request receiver 410, which, upon receiving from the user 102 a request 416 to perform an action 108 during a presence of an individual 202 with the user 102, stores the action 108, associated with the individual 202, in a memory 406 of the device 402. The exemplary system 408 also includes an individual recognizer 412, which detects a presence 210 of individuals 202 with the user 102 (e.g., evaluating an environment sample 418 of an environment of the individual 102 to detect the presence of known individuals 202). The exemplary system 408 also includes an action performer 414, which, when the individual recognizer 412 detects the presence 212, with the user 102, of a selected individual 202 that is associated with a selected action 202 stored in the memory 406, performs the selected action 108 for the user 102. In this manner, the exemplary system 408 causes the device 402 to perform actions 108 involving an individual 108 while the user 102 is in the presence of the individual 202 in accordance with the techniques presented herein.

Still another embodiment involves a computer-readable medium comprising processor-executable instructions configured to apply the techniques presented herein. Such computer-readable media may include, e.g., computer-readable storage devices involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that exclude computer-readable storage devices) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

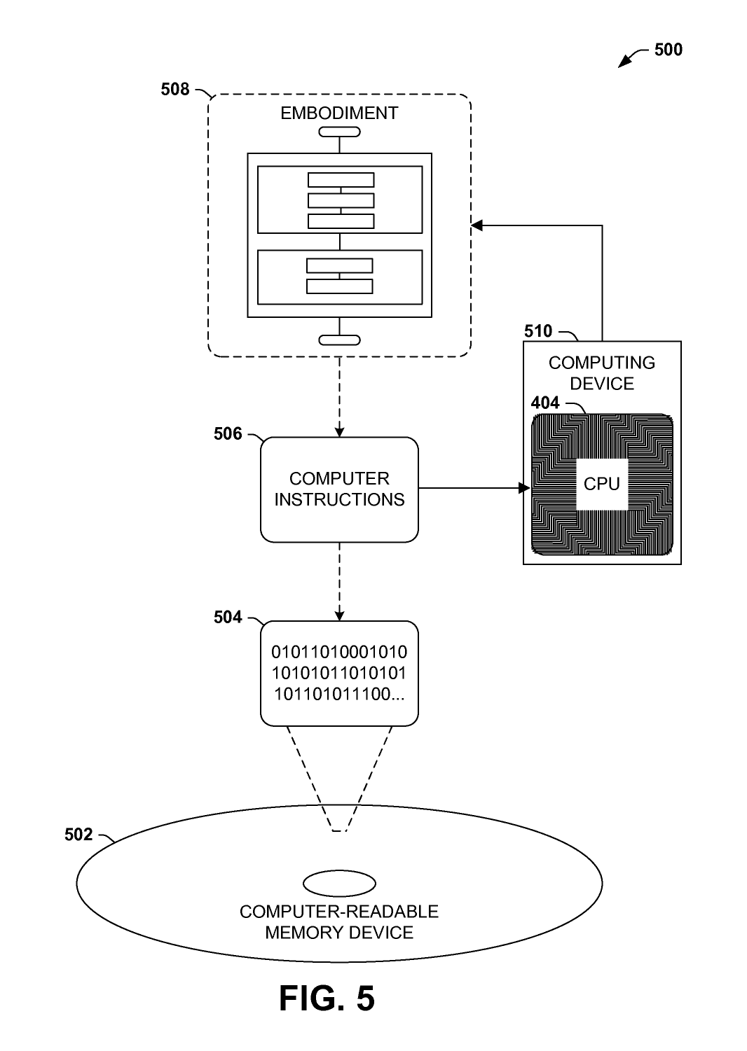

An exemplary computer-readable medium that may be devised in these ways is illustrated in FIG. 5, wherein the implementation 500 comprises a computer-readable memory device 502 (e.g., a CD-R, DVD-R, or a platter of a hard disk drive), on which is encoded computer-readable data 504. This computer-readable data 504 in turn comprises a set of computer instructions 606 that, when executed on a processor 404 of a computing device 510, cause the computing device 510 to operate according to the principles set forth herein. In one such embodiment, the processor-executable instructions 506 may be configured to perform a method 508 of configuring a computing device 410 108 to execute actions 108 involving an individual 202 during a presence of the individual 202 with a user 102 of the computing device 510, such as the exemplary method 300 of FIG. 3. In another such embodiment, the processor-executable instructions 606 may be configured to implement a system configured to cause a computing device 510 to execute actions 108 involving an individual 202 during a presence of the individual 202 with a user 102 of the computing device 510, such as the exemplary system 408 of FIG. 4. Some embodiments of this computer-readable medium may comprise a computer-readable storage device (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

D. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 300 of FIG. 3; the exemplary system 408 of FIG. 4; and the exemplary computer-readable memory device 502 of FIG. 5) to confer individual and/or synergistic advantages upon such embodiments.

D1. Scenarios

A first aspect that may vary among embodiments of these techniques relates to the scenarios wherein such techniques may be utilized.

As a first variation of this first aspect, the techniques presented herein may be utilized to achieve the configuration of a variety of devices 104, such as workstations, servers, laptops, tablets, mobile phones, game consoles, portable gaming devices, portable or non-portable media players, media display devices such as televisions, appliances, home automation devices, and supervisory control and data acquisition (SCADA) devices.

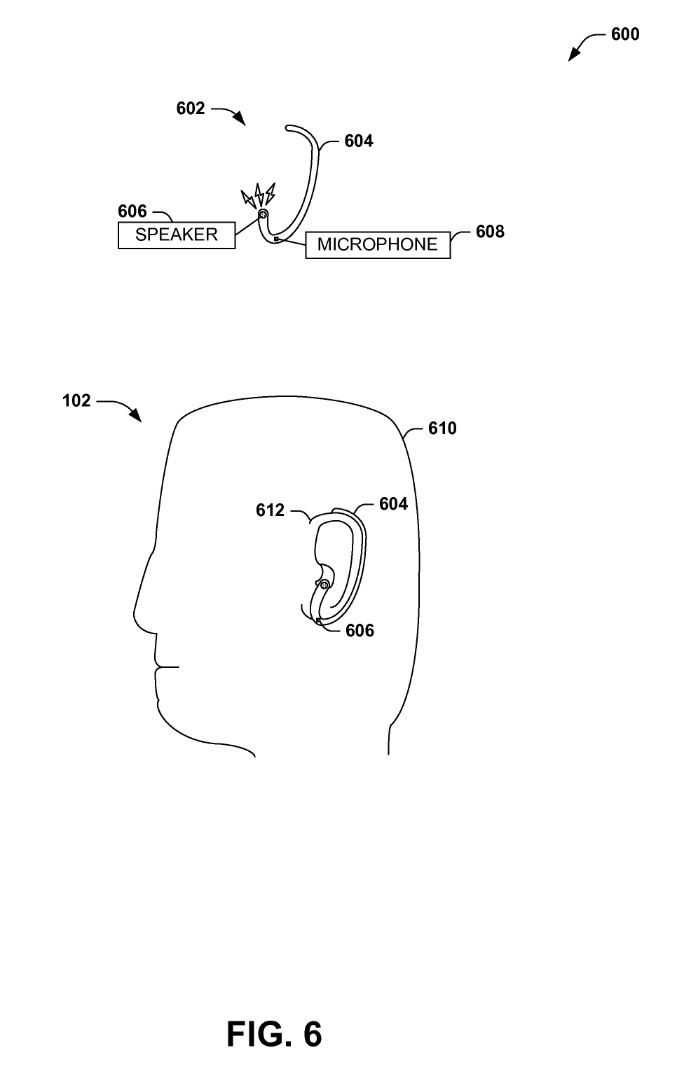

FIG. 6 presents an illustration of an exemplary scenario 600 featuring an earpiece device 602 wherein the techniques provided herein may be implemented. This earpiece device 602 may be worn by a user 102, and may include components that are usable to implement the techniques presented herein. For example, the earpiece device 602 may comprise a housing 604 wearable on the ear 612 of the head 610 of the user 102, and may include a speaker 606 positioned to project audio messages into the ear 612 of the user 102, and a microphone 608 that detects an audio sample of the environment 210 of the user 102. In accordance with the techniques presented herein, the earpiece device 602 may compare the audio sample of the environment 210 with voice identifiers 208 of individuals 202 known to the user 102, and may, upon detecting a match, deduce the presence 212 with the user 102 of the individual 202 represented by the voice identifier 208. The earpiece device 602 may then perform an action 108 associated with the presence 212 of the individual 202 with the user 102, such as playing for the user 102 an audio message of a reminder involving the individual 202 (e.g., “today is Joe's birthday”). In this manner, an earpiece device 602 such as illustrated in the exemplary scenario 600 of FIG. 6 may utilize the techniques presented herein.

As a second variation of this first aspect, the techniques presented herein may be implemented on a combination of such devices, such as a server that stores the actions 108 and the identifiers of respective individuals 202; that receives an environment sample 418 from a second device that is present with an user 102, such as a device worn by the user 102 or a vehicle in which the user 102 is riding; that detects the presence 210 of an individual 202 with the user 102 based on the environment sample 418 from the second device; and that requests the second device to perform an action 108, such as displaying a reminder message for the user 102. Many such variations are feasible wherein a first device performs a portion of the technique, and second device performs the remainder of the technique. As one example, a server may receive input from a variety of devices of the user 102; may deduce the presence of individuals 202 with the user 102 from the combined input of such devices; and may request one or more of the devices to perform an action upon deducing the presence 212 of an individual 202 with the user 102 that is associated with a particular action.

As a third variation of this first aspect, the devices 104 may utilize various types of input devices to detect the presence 212 of respective individuals 202 with the individual 102. Such input devices may include, e.g., still and/or motion cameras capturing images within the visible spectrum and/or other ranges of the electromagnetic spectrum; microphones capturing audio within the frequency range of speech and/or other frequency ranges; biometric sensors that evaluate a fingerprint, retina, posture or gait, scent, or biochemical sample of the individual 202; global positioning system (GPS) receivers; gyroscopes and/or accelerometers; still or motion cameras; microphones; device sensors, such as personal area network (PAN) sensors and network adapters; electromagnetic sensors; and proximity sensors.

As a fourth variation of this first aspect, the devices 104 may receive requests to perform actions 108 from many types of users 102. For example, the device 104 may receive a request from a first user 102 of the device 104 to perform the action 108 upon detecting the presence 212 of an individual 202 with a second user 102 of the device 104 (e.g., the first user 102 may comprise a parent of the second user 102).

As a fifth variation of this first aspect, many types of presence 212 of the individual 202 with the user 102 may be detected by the device 104. As a first such example, the presence 212 may comprise a physical proximity of the individual 202 and the user 102, such as a detection that the individual 202 is within visual sight, audible distance, or physical contact of the user 102. As a second such example, the presence 212 may comprise the initiation of a communication session between the individual 202 and the user 102, such as during a telephone communication or videoconferencing session between the user 102 and the individual 202.

As a sixth variation of this first aspect, the device 104 may be configured to detect a group of individuals 202, such as a member of a particular family, or one of the students in an academic class. The device 104 may store identifiers of each such individual 202, and may, upon detecting the presence 212 of any one of the individuals 202 with the user 102 (e.g., any member of the user's family) or with a collection of the individuals 202 of the group with the user 102 (e.g., detecting all of the members of the user's family), the device 104 may perform the action 108.

As a seventh variation of this first aspect, many types of individuals 202 may be identified in the presence 212 of the user 102. As a first such example, an individual 202 may comprise a personal contact of the user 102, such as the user's family members, friends, or professional contacts. As a second such example, an individual 202 may comprise a person known to the user 102, such as a celebrity. As a third such example, an individual 202 may comprise a type of person, such as any individual appearing to be a mail carrier, which may cause the device 104 to present a reminder to the user 102 to deliver a parcel to the mail carrier for mailing.

As an eighth variation of this first aspect, many types of actions 108 may be performed in response to detecting the presence 212 of the individual 202 with the user 102. Such actions 108 may include, e.g., displaying a message 120 for the user 102; displaying an image; playing a recorded sound; logging the presence 212 of the user 102 and the individual 202 in a journal; sending a message indicating the presence 212 to a second user 102 or a third party; capturing a recording of the environment 210, including the interaction between the user 102 and the individual 202; or executing a particular application on the device 104. Many such variations may be devised that are compatible with the techniques presented herein.

D2. Requests to Perform Actions

A second aspect that may vary among embodiments of the techniques presented herein involves the manner of receiving a request 416 from a user 102 to perform an action 108 upon detecting the presence 212 of an individual 202 with the user 102.

As a first variation of this second aspect, the request 416 may include one or more conditions on which the action 108 is conditioned, in addition to the presence 212 of the individual 202 with the user 102. For example, the user 102 may request the presentation of a reminder message to the user 102 not only when the user 102 encounters a particular individual 202, but if the time of the encounter is within a particular time range (e.g., “if I see Joe before Ann's birthday, remind me to tell him to buy a gift for Ann”). The device 104 may further store the condition with the action 108 associated with and the individual 202, and may, upon detecting the fulfillment of the presence 212 of the individual 202 with the user 102, further determine whether the condition has been fulfilled.

As a second variation of this second aspect, the request 416 may comprise a command directed by the user 102 to the device 104, such as text entry, a gesture, a voice command, or pointing input provided through a pointer-based user interface. The request 416 may also be directed to the device 104 as natural language input, such as a natural-language speech request directed to the device 104 (e.g., “remind me when I see Joe to ask him to buy bread at the market”).

As a third variation of this second aspect, rather than receiving a request 416 directed by the user 102 to the device 104, the device 104 may infer the request 416 during a communication between the user 102 and an individual. For example, the device 104 may evaluate at least one communication between the user and an individual to detect the request 416, where the at least one communication specifies the action and the individual, but does not comprise a command issued by the user 102 to the device 104. For example, the device 104 may evaluate an environment sample 418 of a speech communication between the user 102 and an individual; may apply a speech recognition technique to recognize the content of the user's spoken communication; and may infer, from the recognized speech, one or more requests 416 (e.g., “we should tell Joe to buy bread from the market” causes the device 104 to create an individual presence rule 204 involving a reminder message 120 to be presented when the user 102 is detected to be in the presence 212 of the individual 202 known as Joe). Upon detecting the request 416 in the communication, the device 104 may store the action 108 associated with the individual 202.

As a fourth variation of this second aspect, a device 104 may receive the request 416 from an application executing on behalf of the individual 102. For example, a calendar application may include the birthdates of contacts of the user 102 of the device 104, and may initiate a series of requests 416 for the device 104 to present a reminder message when the user 102 is in the presence of an individual 202 on a date corresponding with the individual's birthdate. These and other techniques may be utilized to receive the request 416 to perform an action 108 while the user 102 is in the presence of an individual 202 in accordance with the techniques presented herein.

D3. Detecting Presence

A third aspect that may vary among embodiments of the techniques presented herein involves the manner of detecting the presence 212 of the individual 202 with the user 102.

As a first variation of this third aspect, the device 104 may compare an environment sample 418 of an environment 210 of the user 102 with various biometric identifiers of respective individuals 102. For example, as illustrated in the exemplary scenario 200 of FIG. 2, the device 104 may store a face identifier 206 of an individual 202, and a face recognizer of the device 104 may compare a photo 218 of the environment 210 of the user 102 with the face identifier 206 of the individual 202. Alternatively or additionally, the device 104 may store a voice identifier 208 of an individual 202, and a voice recognizer of the device 104 may compare an audio recording 220 of the environment 210 of the user 102 with the voice identifier 208 of the individual 202. Other biometric identifiers of respective individuals 202 may include, e.g., a fingerprint, retina, posture or gait, scent, or biochemical identifier of the respective individuals 202.

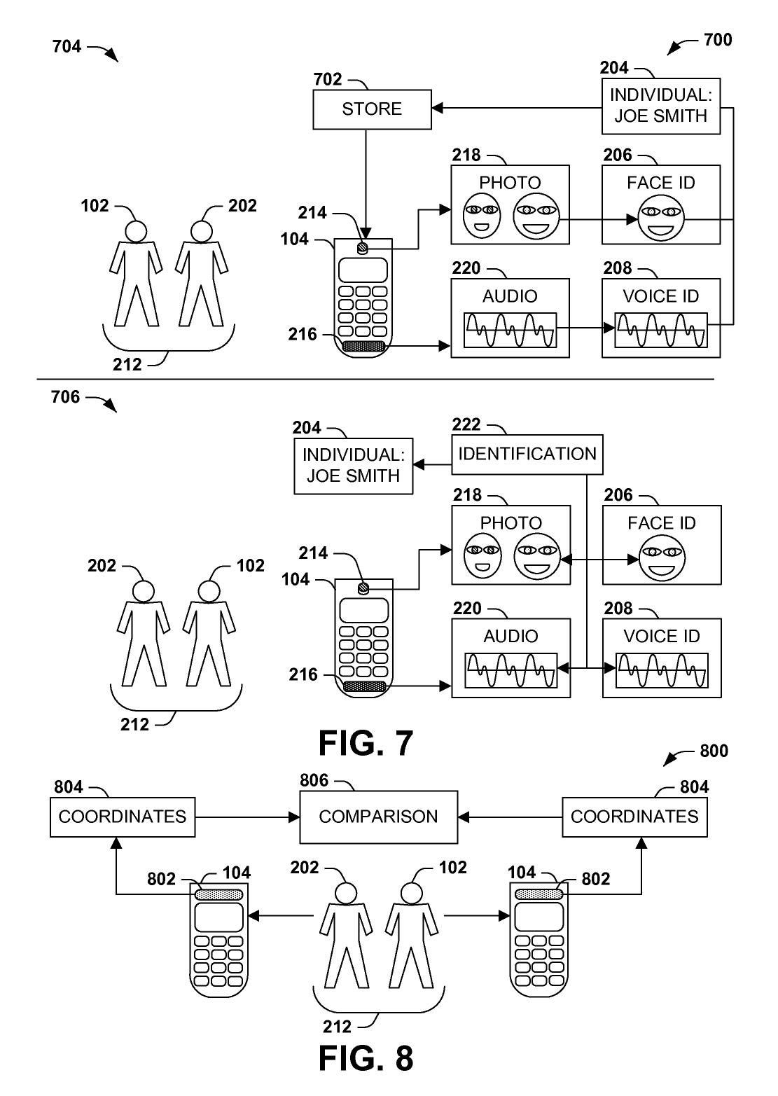

FIG. 7 presents an illustration of an exemplary scenario 700 featuring a second variation of this second aspect, involving one such technique for detecting the presence 212 of an individual 202, wherein, during the presence 212 of the individual 202 with the user 102, the device 104 identifies an individual recognition identifier of the individual 202, and stores the individual recognition identifier of the individual 202, and subsequently detects the presence of the individual 202 with the user 102 according to the individual recognition identifier of the individual 202. In this exemplary scenario 700, at a first time 704, the device 104 may detect an unknown individual 202 in the presence 212 of the user 102. The device 104 may capture various biometric identifiers of the individual 202, such as determining a face identifier 206 of the face of the individual 202 from a photo 218 of the individual 202 captured with a camera 214 during the presence 212, and determining a voice identifier 220 of the voice of the individual 202 in an audio sample captured with a microphone 216 during the presence 212 of the individual 202. These biometric identifiers may be stored 702 by the device 104, and may associated with an identity of the individual 202 (e.g., achieved by determining the individuals 202 anticipated to be in the presence of the user 102, such as according to the user's calendar; by comparing such biometric identifiers with a source of biometric identifiers of known individuals 202, such as a social network; or simply by asking the user 102 at a current or later time to identify the individual 202). At a second time 706, when the user 102 is again determined to be in the presence of an individual 202, the device 104 may capture a second photo 218 and/or a second audio sample 220 of the environment 210 of the user 102, and may compare such environment samples with the biometric identifiers of known individuals 202 to deduce the presence 212 of the individual 202 with the user 102.

FIG. 8 presents an illustration of an exemplary scenario 800 featuring a third variation of this second aspect, wherein the device 104 comprises a user location detector that detects a location of the user 102, and an individual location detector of the device 104 that detects a location of the individual 202, and compares the location of the selected individual 202 and the location of the user 102 to determine the presence 212 of the individual 202 with the user 102. For example, both the user 102 and the individual 202 may carry a device 104 including a global positioning system (GPS) receiver 802 that detects the coordinates 804 of each person. A comparison 806 of the coordinates 804 may enable a deduction that the devices 104, and by extension the user 102 and the individual 202, are within a particular proximity, such as within ten feet of one another. The device 104 of the user 102 may therefore perform the action 108 associated with the individual 202 during the presence of the individual 202 and the user 102.

As a fourth variation of this second aspect, the device 104 of the user 102 may include a communication session detector that detects a communication session between the user 102 and the individual 202, such as a voice, videoconferencing, or text chat session between the user 102 and the individual 202. This detection may be achieved, e.g., by evaluating metadata of the communication session to identify the individual 202 as a participant of the communication session, or by applying biometric identifiers to the media stream of the communication session (e.g., detecting the voice of the individual 202 during a voice session, and matching the voice with a voice identifier 208 of the individual 202).

As a fifth variation of this second aspect, the presence 212 of the individual 202 with the user 102 may be detected by detecting a signal emitted by a device associated with the individual 202. For example, a mobile phone that is associated with the individual may emit a wireless signal, such as a cellular communication signal or a WiFi signal, and the signal may include an identifier of the device. If the association of the device with the individual 202 is known, then the identifier in the signal emitted by the device may be detected and interpreted as the presence of the individual 202 with the user 102.

As a sixth variation of this second aspect, the detection of presence 212 may also comprise verifying the presence of the user 102 in addition to the presence 212 of the individual 202. For example, in addition to evaluating a photo 218 of the environment 210 of the user 102 to identify a face identifier 206 of the face of the individual 202, the device 104 may also evaluate the photo 218 to identify a face identifier 206 of the face of the user 102. While it may be acceptable to presume that the device 104 is always in the presence of the user 102, it may be desirable to verify the presence 212 of the user 102 in addition to the individual 202. For example, this verification may distinguish an encounter between the individual 202 and the user's device 104 (e.g., if the individual 202 happens to encounter the user's device 104 while the user 102 is not present) from the presence 212 of the individual 202 and the user 102. Alternatively or additionally, the device 104 may interpret a recent interaction with the device 104, such as a recent unlocking of the device 104 with a password, as an indication of the presence 212 of the user 102.

As a seventh variation of this second aspect, the device may use a combination of identifiers to detect the presence 212 of an individual 202 with the user 102. For example, the device 104 may concurrently detect a face identifier of the individual 202, a voice identifier of the individual 202, and a signal emitted by a second device carried by the individual 202, in order to verify the presence 212 of the individual 202 with the user 102. The evaluation of combinations of such signals may, e.g., reduce the rate of false positives (such as incorrectly identifying the presence 212 of an individual 202 through a match of a voice identifier with the voice of a second individual with a voice similar to the first individual), and the rate of false negatives (such as incorrectly failing to identify the presence 21 of an individual 202 due to a change in identifier, e.g., the individual's voice identifier may not match while the individual 202 has laryngitis). Many such techniques may be utilized to detect the presence of the individual 202 with the user 102 in accordance with the techniques presented herein.

D4. Performing Actions

A fourth aspect that may vary among embodiments of the techniques presented herein involves the performance of the actions 108 upon detecting the presence 212 of the individual 202 with the user 102.

As a first variation of this fourth aspect, one or more conditions may be associated with an action 108, such that the condition is to be fulfilled during the presence 212 of the individual 202 with the user 102 before performing the respective actions 108. For example, a condition may specify that an action 108 is to be performed only during a presence 212 of the individual 202 with the user 102 during a particular range of times; in a particular location; or while the user 102 is using a particular type of application on the device 104. Such conditions associated with an action 108 may be evaluated in various ways. As a first such example, the conditions may be periodically evaluated to detect a condition fulfillment. Alternatively, a trigger may be generated, such that the device 104 may instruct a trigger detector to detect a condition fulfillment of the condition, and to generate a trigger notification when the condition fulfillment is detected.

As a second variation of this fourth aspect, the detection of presence 212 and the invocation of actions 108 may be limited in order to reduce the consumption of computational resources of the device 104, such as the capacity of the processor, memory, or battery, and the use of sensors such as a camera and microphone. As a first such example, the device 104 may evaluate the environment 210 of the user 102 to detect the presence 212 of the individual 104 with the user 102 only when conditions associated with the action 108 are fulfilled, and may otherwise refrain from evaluating the environment 210 in order to conserve battery power. As a second such example, the device 104 may detect the presence 212 of the individual 202 with the user 102 only during an anticipated presence of the individual 104 with the user 102, e.g., only in locations where the individual 202 and the user 102 are likely to be present together.

As a third variation of this fourth aspect, the evaluation of conditions may be assisted by an application on the device 104. For example, the device 104 may comprise at least one application that provides an application condition for which the application is capable of detecting a condition fulfillment. The device 104 may store the condition when a request specifying an application condition in a conditional action is received, and may evaluate the condition by invoking the application to determine the condition fulfillment of the application condition. For example, the application condition may specify that the presence 212 of the individual 202 and the user 102 occurs in a market. The device 104 may detect a presence 212 of the individual 202 with the user 102, but may be unable to determine if the location of the presence 212 is a market. The device 104 may therefore invoke an application that is capable of comparing the coordinates of the presence 212 with the coordinates of known marketplaces, in order to determine whether the user 102 and the individual 202 are together in a market.

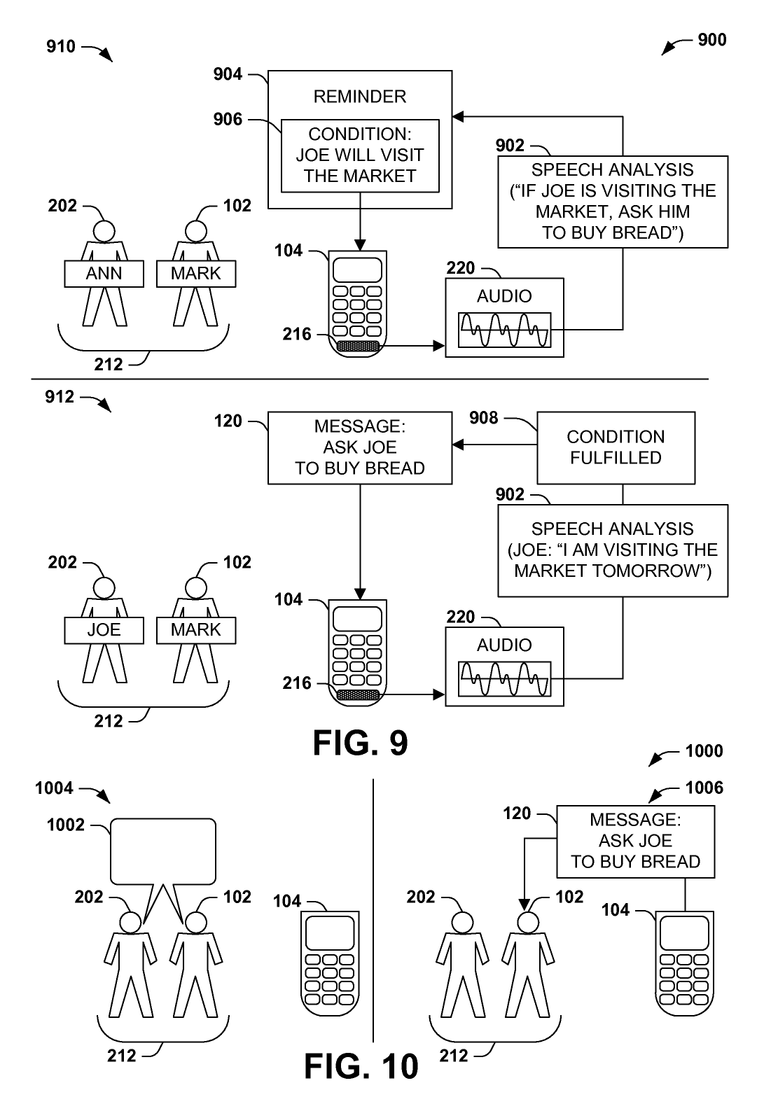

FIG. 9 presents an illustration of an exemplary scenario 900 featuring a fourth variation of this fourth aspect, wherein the device 104 of a user 102 may evaluate at least one communication between the user 102 and an individual 202 to detect the condition fulfillment of a condition, where the communication does not comprise a command issued by the user 102 to the device 104. In this exemplary scenario 900, at a first time 910, the device 104 may detect the presence 212 of a first individual 102 with the user 102. The device 104 may invoke a microphone 216 to generate an audio sample 220 of the communication, and may perform speech analysis 902 to detect, in the communication between the user 102 and the individual 202, a request 416 to perform an action 108 when the user 10 has a presence 212 with a second individual 102 named Joe (“ask Joe to buy bread”), but only if a condition 906 is satisfied (“if Joe is visiting the market”). The device 104 may store a reminder 904 comprising the action 108, the condition 906, and the second individual 202. At a second time 912, the device 104 may detect a presence 212 of the user 102 with the second individual 202, and may again invoke the microphone 216 to generate an audio sample 220 of the communication between the user 102 and the second individual 202. Speech analysis 902 of the audio sample 220 may reveal a fulfillment of the condition (e.g., the second individual may state that he is visiting the market tomorrow”). The device 104 may detect the condition fulfillment 908 of the condition 906, and may perform the action by presenting a message 120 to the user 102 during the presence 212 of the individual 102.

As a fifth variation of this fourth aspect, a device 104 may perform the action 108 in various ways. As a first such example, the device 104 may involve a non-visual communicator, such as a speaker directed to an ear of the user 102, or a vibration module, and may present a non-visual representation of a message to the user, such as audio directed into the ear of the user 102 or a Morse-encoded message. Such presentation may enable the communication of messages to the user 102 in a more discrete manner than a visual message that is also viewable by the individual 202 during the presence 212 with the user 102.

FIG. 10 presents an illustration of an exemplary scenario 1000 featuring a sixth variation of this fourth aspect, wherein an action 108 is performed during a presence 212 of the individual 202 with the user 102, but in a manner that avoids interrupting an interaction 1002 of the individual 202 and the user 102. In this exemplary scenario 1000, at a first time 104, the device 104 detects an interaction between the user 102 and the individual 202 (e.g., detecting that the user 102 and the individual 202 are talking), and thus refrains from performing the action 108 (e.g., refraining from presenting an audio or visual message to the user 102 during the interaction 1002). At a second time 1006, the device 104 may detect a suspension of the interaction 1002 (e.g., a period of non-conversation), and may then perform the action 108 (e.g., presenting the message 120 to the user 102). In this manner, the device 104 may select the timing of the performance of the actions 108 in order to avoid interrupting the interaction 1002 between the user 102 and the individual 202. Many such variations in the performance of the actions 108 may be included in implementations of the techniques presented herein.

E. Computing Environment

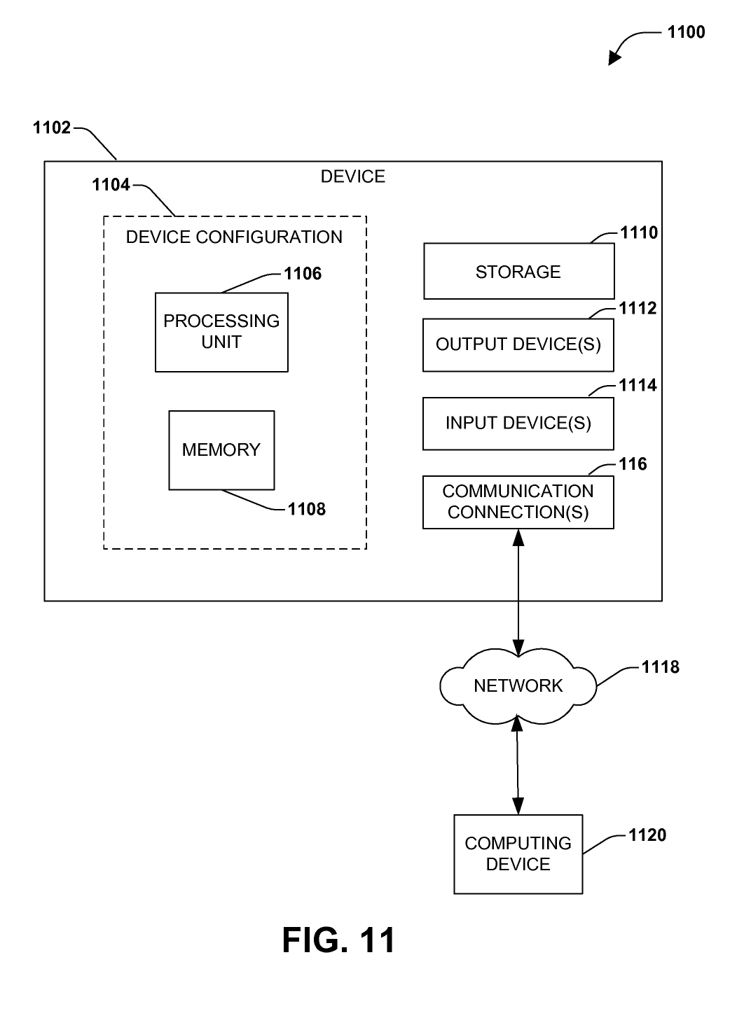

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1102 configured to implement one or more embodiments provided herein. In one configuration, computing device 1102 includes at least one processing unit 1106 and memory 1108. Depending on the exact configuration and type of computing device, memory 1108 may be volatile (such as RAM, for example), non-volatile (such as ROM, flash memory, etc., for example) or some combination of the two. This configuration is illustrated in FIG. 11 by dashed line 1104.

In other embodiments, device 1102 may include additional features and/or functionality. For example, device 1102 may also include additional storage (e.g., removable and/or non-removable) including, but not limited to, magnetic storage, optical storage, and the like. Such additional storage is illustrated in FIG. 11 by storage 1110. In one embodiment, computer readable instructions to implement one or more embodiments provided herein may be in storage 1110. Storage 1110 may also store other computer readable instructions to implement an operating system, an application program, and the like. Computer readable instructions may be loaded in memory 1108 for execution by processing unit 1106, for example.

The term “computer readable media” as used herein includes computer-readable storage devices. Such computer-readable storage devices may be volatile and/or nonvolatile, removable and/or non-removable, and may involve various types of physical devices storing computer readable instructions or other data. Memory 1108 and storage 1110 are examples of computer storage media. Computer-storage storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 1102 may also include communication connection(s) 1116 that allows device 1102 to communicate with other devices. Communication connection(s) 1116 may include, but is not limited to, a modem, a Network Interface Card (NIC), an integrated network interface, a radio frequency transmitter/receiver, an infrared port, a USB connection, or other interfaces for connecting computing device 1102 to other computing devices. Communication connection(s) 1116 may include a wired connection or a wireless connection. Communication connection(s) 1116 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1102 may include input device(s) 1114 such as keyboard, mouse, pen, voice input device, touch input device, infrared cameras, video input devices, and/or any other input device. Output device(s) 1112 such as one or more displays, speakers, printers, and/or any other output device may also be included in device 1102. Input device(s) 1114 and output device(s) 1112 may be connected to device 1102 via a wired connection, wireless connection, or any combination thereof. In one embodiment, an input device or an output device from another computing device may be used as input device(s) 1114 or output device(s) 1112 for computing device 1102.

Components of computing device 1102 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1102 may be interconnected by a network. For example, memory 1108 may be comprised of multiple physical memory units located in different physical locations interconnected by a network.

Those skilled in the art will realize that storage devices utilized to store computer readable instructions may be distributed across a network. For example, a computing device 1120 accessible via network 1118 may store computer readable instructions to implement one or more embodiments provided herein. Computing device 1102 may access computing device 1120 and download a part or all of the computer readable instructions for execution. Alternatively, computing device 1102 may download pieces of the computer readable instructions, as needed, or some instructions may be executed at computing device 1102 and some at computing device 1120.

F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of performing for a user an action pertaining to an individual on a device having a processor, the method comprising:
executing on the processor instructions that cause the device to:
upon receiving a request to perform an action during a presence of an individual with the user, store the action associated with the individual; and
upon detecting a presence of the individual with the user, perform the action.

2. The method of claim 1, wherein receiving the request further comprises:
evaluating at least one communication between the user and an individual to detect the request, where the at least one communication does not comprise a command issued by the user to the device, and where the at least one communication specifies the action and the individual; and
upon detecting the request in the at least one communication, store the action associated with the individual.

3. The method of claim 1, wherein receiving the request further comprises: upon receiving, from an application executing on behalf of the user, a request to perform an action during the presence of the individual with the user, store the action associated with the individual.

4. The method of claim 1, wherein performing the action further comprises:
detecting an interaction between the user and the individual;
during the interaction between the user and the individual, refraining from performing the action; and
during a suspension of the interaction between the user and the individual, perform the action.

5. The method of claim 1, wherein detecting the presence of the individual with the user further comprises: verifying the presence of the user.

6. The method of claim 1, wherein:
the device further comprises a non-visual communicator;
the action further comprises a message to be presented to the user during the presence of the individual; and
performing the action further comprises: using the non-visual communicator, presenting a non-visual representation of the message to the user.

7. A device configured to perform actions pertaining to individuals on behalf of a user, the device having a memory and comprising:
a request receiver that, upon receiving from the user a request to perform an action during a presence of an individual with the user, stores the action in the memory associated with the individual;
an individual recognizer that detects a presence of individuals with the user; and
an action performer that, upon the individual recognizer detecting the presence, with the user, of a selected individual that is associated with a selected action stored in the memory, performs the selected action.

8. The device of claim 7, wherein the individual recognizer further comprises:
a camera that receives an image of an environment of the user; and
an individual recognizer that recognizes the selected individual in the image of the environment of the user.

9. The device of claim 7, wherein:
the memory stores a face identifier of a face of the selected individual; and
the individual recognizer further comprises a face recognizer that matches the face of the selected individual in the image of the environment of the user with the face identifier of the selected individual.

10. The device of claim 7, wherein:
the memory stores a voice identifier of a voice of the selected individual;
the device further comprises an audio receiver that receives an audio sample of an environment of the individual; and
the individual recognizer further comprises a voice recognizer that identifies the voice identifier of the voice of the selected individual in the audio sample of the environment of the individual.

11. The device of claim 7, wherein:
the individual recognizer further comprises: during a presence of the individual with the user:
identify an individual recognition identifier of the individual, and
store the individual recognition identifier of the individual; and
the individual recognizer detects the presence of the individual with the user according to the individual recognition identifier of the individual.

12. The device of claim 7, wherein the individual recognizer further comprises:
a user location detector that detects a location of the user; and
an individual location detector that:
detects a location of the selected individual, and
compares the location of the selected individual and the location of the user to determine a presence of the selected individual with the user.

13. The device of claim 7, wherein the individual recognizer further comprises: a communication session detector that detects a communication session between the user and the individual.

14. A computer-readable memory device storing instructions that, when executed on a processor of a device having a memory, cause the device to perform actions pertaining to individuals on behalf of a user, by:
upon receiving from the user a request to perform an action during a presence of an individual with the user, storing the action associated with the individual in the memory of the device; and
upon detecting a presence with the user of a selected individual that is associated with a selected reminder stored in the memory, perform the action on behalf of the user.

15. The computer-readable memory device of claim 14, wherein detecting the presence with the user further comprises:
determining an anticipated presence of the selected individual with the user; and
only during the anticipated presence of the selected individual with the user, detecting the presence of the selected individual with the user.

16. The computer-readable memory device of claim 14, wherein:
receiving the request from the user further comprises: upon receiving from the user at least one condition in which the action is to be performed, store the at least one condition in the memory of the device associated with the action; and
performing the action further comprises:
evaluating the at least one condition associated with the action to detect a condition fulfillment; and
upon detecting the presence with the user of the selected individual and the condition fulfillment of the at least one condition of the action, performing the action on behalf of the user.

17. The computer-readable memory device of claim 16, wherein evaluating the at least one condition further comprises: periodically evaluating the at least one condition associated with the action to detect a condition fulfillment.

18. The computer-readable memory device of claim 16, wherein:
evaluating the at least one condition further comprises: instructing a trigger detector of the device to, upon detecting the condition fulfillment of the at least one condition, initiate a trigger notification; and
detecting the condition fulfillment of the at least one condition of the action further comprising: receiving from the trigger detector the trigger notification of the condition fulfillment of the at least one condition.

19. The computer-readable memory device of claim 14, wherein:
at least one application provides an application condition for which the application is capable of detecting a condition fulfillment, store the condition; and
evaluating the at least one condition associated with the action further comprises: for an action associated with the application condition, invoke the application to determine the condition fulfillment of the application condition.

20. The computer-readable memory device of claim 16, wherein evaluating the at least one condition further comprises: evaluating at least one communication between the user and an individual to detect the condition fulfillment of the at least one condition, where the communication does not comprise a command issued by the user to the device.
